(19) United States
(12) Patent Application Publication
(10) Pub. No.: US 2004/0240654 A1
(43) Pub. Date: Dec. 2, 2004

(54) Telephone exchange method and telephone exchange system

(75) Inventor: Takahiro Ozaki, Tokyo (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/855,524

(22) Filed: May 28, 2004

(30) Foreign Application Priority Data
May 29, 2003 (JP) 2003-152739

(51) Int. Cl. H04M 3/42

(52) U.S. Cl. 379/211.02

(57) ABSTRACT

Conditions for forwarding a call addressed to a personal DN are set for respective users in advance, and are stored in a telephone exchange system. The telephone exchange system recognizes a place to which a user moves when the user logs in to a forwarding telephone terminal of the user, and determines a destination to which the call is forwarded by using the conditions corresponding to the place to which the user moves and information on a caller contained in the call, thereby forwarding the call to the destination.

### CROSS-REFERENCE TO RELATED APPLICATIONS

This application is based upon and claims the benefit of priority from the prior Japanese patent application No. 2003-152739 filed on May 29, 2003; the entire contents of which are incorporated herein by reference.

### BACKGROUND OF INVENTION

1. Field of the Invention

The present invention relates to a telephone exchange method and a telephone exchange system, and more particularly to a telephone exchange method and a telephone exchange system capable of forwarding a call addressed to a person to a telephone terminal located at the place where the person moved in a private telephone system in which an extension network is installed across a premise of a company or a factory.

2. Description of Related Art

In a private telephone system in which an extension network is installed across the premise of a company or a factory, extension numbers (terminal DNs) are assigned to respective telephone terminals, and a call is received by a desired terminal by using this terminal DN.

In a circumstance where a telephone terminal is assigned to each person (user), a forward service has been proposed in which each user can designate a telephone terminal to which a call to the user is forwarded (hereinafter called “forwarding telephone terminal”), and a call addressed to a terminal DN possessed by the telephone terminal assigned to the user is forwarded to the forwarding telephone terminal (refer to, for example, Japanese patent application publication No. 2001-285496).

Incidentally, extension numbers can be assigned to persons as well as to the telephone terminals. In a circumstance where extension numbers are assigned to persons, a forward service has been proposed in which a call addressed to an extension number assigned to a person (personal DN) is forwarded to a telephone terminal to which the person (user) has logged in.

FIG. 5 is a schematic block diagram illustrating a configuration of a telephone exchange system that forwards a call addressed to a personal DN to a forwarding telephone terminal.

This telephone exchange system 40 comprises a personal DN/terminal DN setting unit 41 that associates a personal DN with a terminal DN and updates an association table, not shown, by logging in to a forwarding telephone terminal by a user; a personal DN/terminal DN retrieval unit 42 that carries out a retrieval based on the association table so as to find the place to which a use moves (login destination) from the personal DN; and a call control unit 43 that receives a call and forwards the call to an appropriate telephone terminal.

In the telephone exchange system 40, when a user moves in a premise of his/her company or factory, and logs in to a telephone terminal 50 located at a place to which the user moves, the personal DN/terminal DN setting unit 41 updates the association table indicating the association between the personal DNs and the terminal DNs, and associates a personal DN with the terminal DN of the telephone terminal to which the user logs in.

when the call control unit 43 receives a call designating the personal DN from a caller 51, the personal DN/terminal DN retrieval unit 42 searches the association table to find the terminal DN of the forwarding telephone terminal, and the call control unit 43 forwards the call to the telephone terminal 50 having the terminal DN thus found.

FIG. 6 is a flowchart illustrating operations of the telephone exchange system 40. First, a call is received (step S200), a terminal DN associated with a personal DN to which the call is addressed is searched (step S201), the destination of the call is converted into the detected terminal DN (step S202), and the call is forwarded to the terminal DN (step S203).

There are, however, such occasions that a user moved to, for example, a meeting room to attend a conference and he/she does not wish to receive any calls or wishes to receive only specific calls.

On the other hand, there is an occasion in which a caller forwards a call at a specific location expecting that an addressed user is present at this specific location. In such an occasion, the caller may think that he/she achieved a purpose of the calling because he/she knows a location where the call is received even though communication with the addressed user is not established.

As appreciated from the foregoing description, when a call addressed to a personal DN is forwarded to a telephone terminal located at a place to which an addressed user moves, users may require various conditions on which they wish to receive calls. However, setting such conditions is complicated and requires a time, and thus, it is difficult for users to perform such setting immediately before their moving.

### SUMMARY OF THE INVENTION

The present invention has been made in view of the above circumstances and may provide a telephone exchange method and a telephone exchange system that forwards a call addressed to a personal DN to a place to which a user moves according to requirements of respective users.

According to an aspect of the present invention, a telephone exchange method of forwarding a call addressed to a personal DN, which is a number assigned to a user, to a forwarding telephone terminal located at a place to which the user moves, comprises storing a terminal DN, which is a number assigned to a telephone terminal to which the user logs in, and the personal DN, the terminal DN being associated with the personal DN; searching a terminal DN associated with the personal DN to which the call is addressed, thereby recognizing a place to which the user moves; detecting caller information of the call from the call; determining a destination to which the call is forwarded according to a reception condition which is a condition for determining the destination to which the call is forwarded based on the place to which the user moves and the caller information; and forwarding the call to the destination to which the call is forwarded.

With this configuration, a destination to which the call is forwarded can be finely set according to a place to which a user moves.

According to another aspect of the present invention, a telephone exchange system for forwarding a call addressed to a personal DN, which is a number assigned to a user, to a forwarding telephone terminal located at a place to which the user moves, comprises a personal DN/terminal DN setting unit that associates a terminal DN, which is a number assigned to a telephone terminal to which the user logs in, with the personal DN; a personal DN/terminal DN retrieval unit that searches a terminal DN associated with the personal DN to which the call is addressed, thereby recognizing a place to which the user moves; a caller information detection unit that detects caller information of the call from the call; a reception condition storage unit that stores reception conditions in a destination to which the call is forwarded; a forwarding destination determination unit that determines a destination to which the call is forwarded according to the reception conditions based on the destination to which the call is forwarded and the caller information; and a call control unit that forwards the call to the destination to which the call is forwarded.

According to the present invention, a call can be forwarded according to finely specified requirements for respective users.

### BRIEF DESCRIPTION OF THE DRAWINGS

In the accompanying drawings,

FIG. 1 is a schematic block diagram illustrating an overall configuration of a telephone exchange system according to an embodiment of the present invention;

FIG. 2 shows an example of a script file according to the embodiment of the present invention;

FIG. 3 is a flowchart illustrating operations of the telephone exchange system according to the embodiment;

FIG. 4 is a flowchart illustrating the operations of the telephone exchange system according to the embodiment;

FIG. 5 is a schematic block diagram illustrating a configuration of a conventional telephone exchange system; and

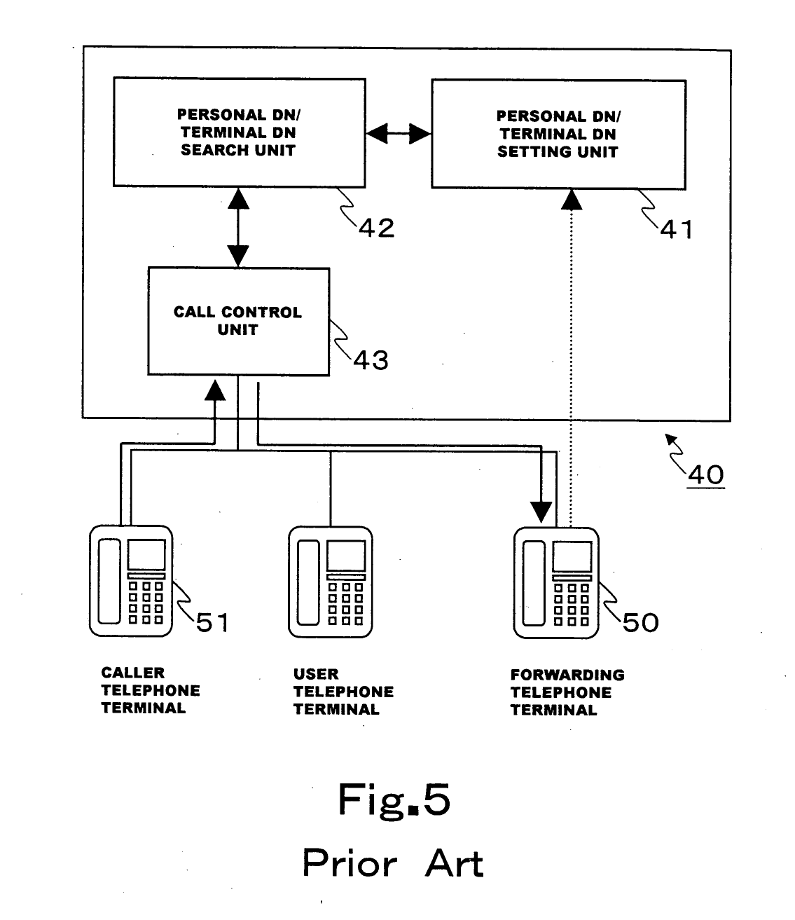

FIG. 6 is a flowchart illustrating operations of the conventional telephone exchange system.

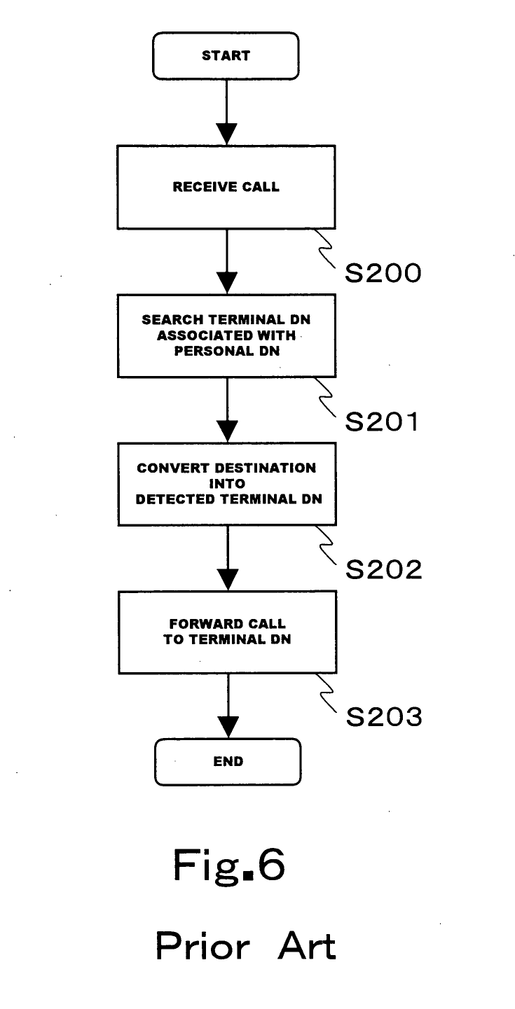

### DESCRIPTION OF THE EMBODIMENTS

A detailed description will now be given of a telephone exchange method and a telephone exchange system according to an embodiment of the present invention with reference to the accompanying drawings.

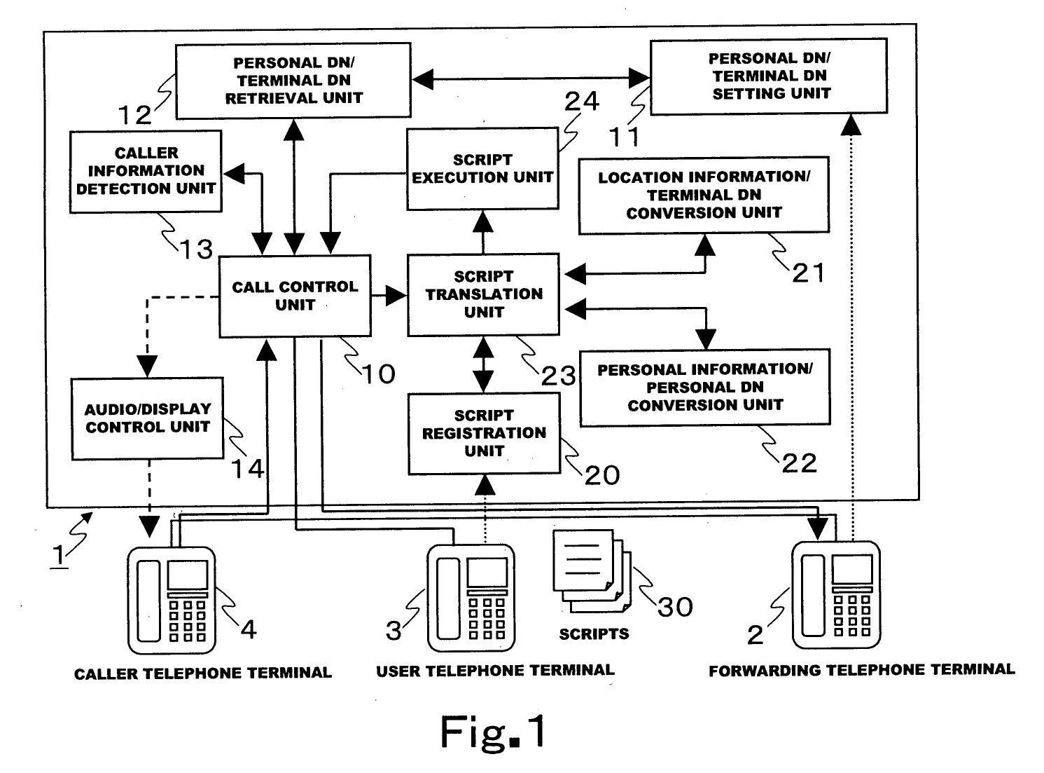

FIG. 1 is a schematic block diagram illustrating an overall configuration of the telephone exchange system according to an embodiment of present invention.

The telephone exchange system 1 comprises a call control unit 10 that carries out control for forwarding a received call to an appropriate destination, a personal DN/terminal DN setting unit 11 that carries out setting that associates a personal DN with a terminal DN of a telephone terminal to which a user logs in, a personal DN/terminal DN retrieval unit 12 that detects a forwarding destination terminal DN of a user based on a personal DN thereof, a caller information detection unit 13 that detects a personal DN, a line type, etc. of the caller based on information contained in the call, and an audio/display control unit 14 that carries out control for notifying a message of the caller to a telephone terminal and displaying a message on the display screen of the telephone terminal.

The telephone exchange system 1 further comprises a script registration unit 20 that registers script files describing system operations when a call is received, a location information/terminal DN conversion unit 21 that converts location information indicating a location into a terminal DN, a personal information/personal DN conversion unit 22 that converts the name of a person into a personal DN, a script translation unit 23 that translates a script file into an executable form, and a script execution unit 24 that gives instructions to the call control unit 10 according to the description in the script file.

When a user logs in to a forwarding telephone terminal 2, the personal DN/terminal DN setting unit 11 updates an association table indicating the association between the personal DN of the user and the terminal DN of a terminal to which the user logs in, and associates the personal DN with the terminal DN of the terminal to which the user logs in.

Then, if a destination is a personal DN, the personal DN/terminal DN retrieval unit 12 searches the association table in the personal DN/terminal DN setting unit 11, and detects the terminal DN of the forwarding telephone terminal 2 located at the place to which the user moves (login destination).

The script registration unit 20 registers a script file for each personal DN. The script file describes the operations of the system when a call addressed to a personal DN is received. For example, the operation of the system is “forwarding a call to a voice mail if a telephone terminal 2 at the login destination to which the user logs in is installed in a meeting room”.

The script file 30 is registered when a user inputs the script file 30 to the script registering unit 20 through a telephone terminal to which the user logs in, such as a telephone terminal 3 that the user usually uses.

The script file is input to the registration unit 20 through an external apparatus such as a PC (personal computer) and a PDA (personal digital assistant) connectable to the telephone terminal via an interface, not shown, or through a touch panel or keys for inputting numbers for dialing provided on the telephone terminal, for example.

The script translation unit 23 uses the location information/terminal DN conversion unit 21 or the personal information/personal DN conversion unit 22 to convert the name of a location such as a meeting room or a reception room, or the name of a person stated in a script file so that the script file is translated into an executable form.

In the telephone exchange system 1 of the above-described configuration according to the embodiment of the present invention, when a user logs in to the telephone terminal 2 located in the neighborhood of a place to which the user moves by inputting, for example, an ID number or a password identifying the user into the telephone terminal 2, the personal DN/terminal DN setting unit 11 updates the association table that indicates an association between a personal DN and a terminal DN, and associates the personal DN with the terminal DN of the telephone terminal 2 to which the user logs in.

Then, when the call control unit 10 receives a call designating a personal DN from a telephone terminal 4 of a caller, the personal DN/terminal DN retrieval unit 12 searches the association table and detects the destination (login destination) to which the user moves, if a destination of the call is the personal DN.

The caller information detection unit 13 detects information such as the personal DN of the caller or a line type (extension, external line, etc.) from the information contained in the call.

The script translation unit 23 searches a script file corresponding to the personal DN to which the call is addressed from script files registered in the script registration unit 20, and then, converts the searched script file into an executable form by using the location information/terminal DN conversion unit 21 that converts the name of a location into a terminal DN, and the personal information/personal DN conversion unit 22 that converts the name of a person into a personal DN.

The script execution unit 24 gives an instruction to the call control unit 10 according to the description of the script file that has been translated into the executable form by the script translation unit 23.

Then, the call control unit 10 causes the terminal DN (telephone terminal 2 at the place to which the user moves) associated with the personal DN to receive the call, and forwards and displays a message to the telephone terminal 4 of the caller through the audio/display control unit 14 according to the instruction from the script execution unit 24 and the information detected by the caller information detection unit 13.

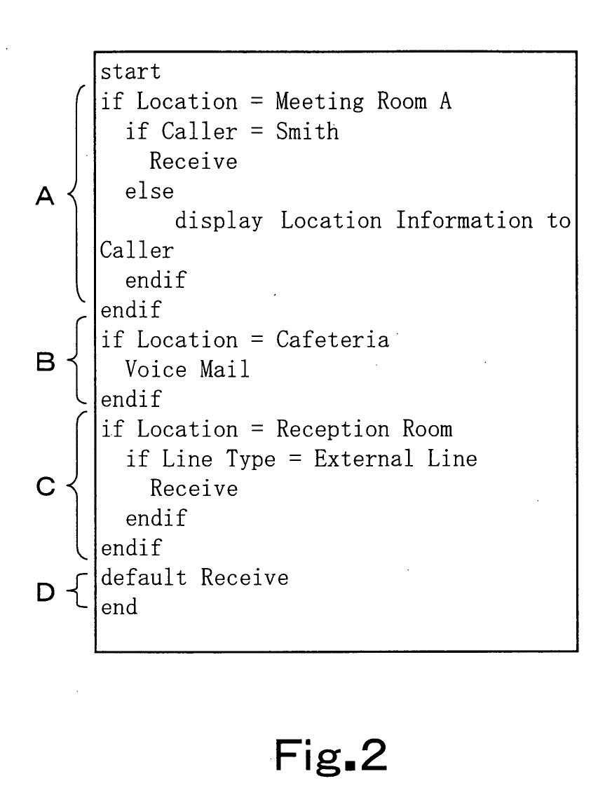

FIG. 2 shows an example of the script file. In FIG. 2, a range A shows a setting in which if the place to which a user moves is “Meeting room A”, a telephone terminal to which the user logs in receives the call if the caller is “Smith”, and location information is shown on the telephone terminal of the caller if the caller is not “Smith”.

A range B shows a setting in which if the place to which the user moves is “Cafeteria”, the call is forwarded to “Voice Mail”. A range C shows a setting in which if the place to which the user moves is “Reception Room”, and if the line type is “External line”, then the telephone terminal to which the user logs in is caused to receive the call. A range D shows a setting in which if the destination to which the call is forwarded is a location other than those indicated in the ranges A through C, the telephone terminal to which the user logs in receives the call.

As described above, since the forward conditions according to the present invention are set using a script file in which the conditions relating to the forwarding of the call are described in statement, and therefore the user can set the conditions for forwarding the call easily, flexibly and in detail.

Further, the name of a location and the name of a person can be indicated in a natural language as the location information and the personal information. The name of a location and the name of a person are then converted into the terminal DN and the personal DN, respectively, by the script translation unit in the telephone exchange system.

As a result, the conditions can be set by directly inputting the name of a locations such as a meeting room or a reception room and the name of a persons, and therefore, the operations for setting the conditions can be carried out simply by entering the names at predetermined positions in statements described in the script in advance.

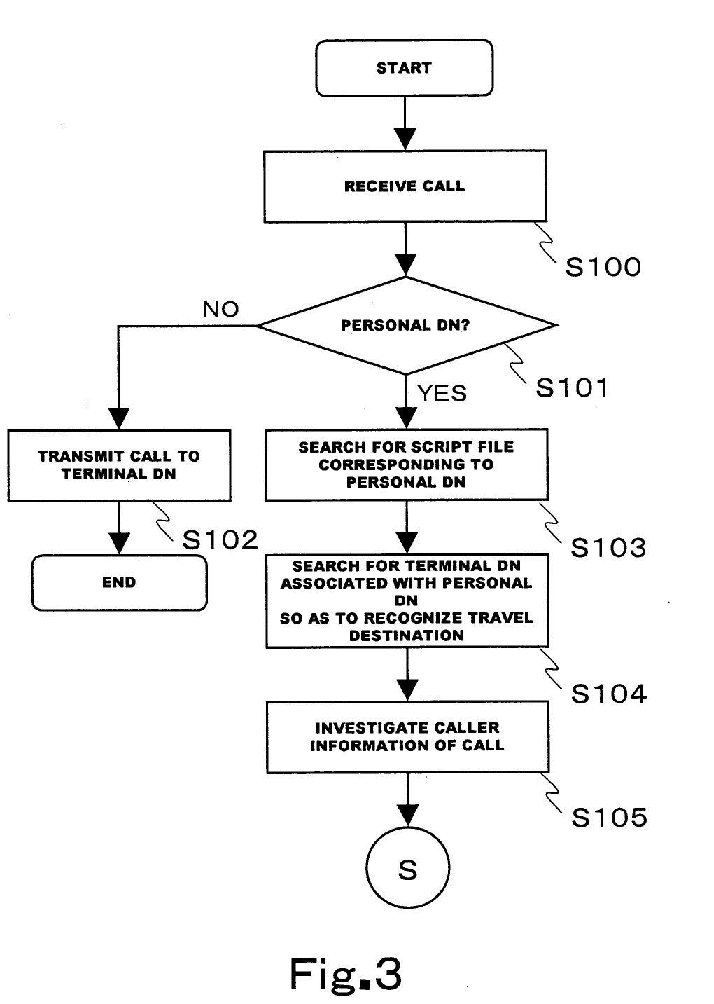

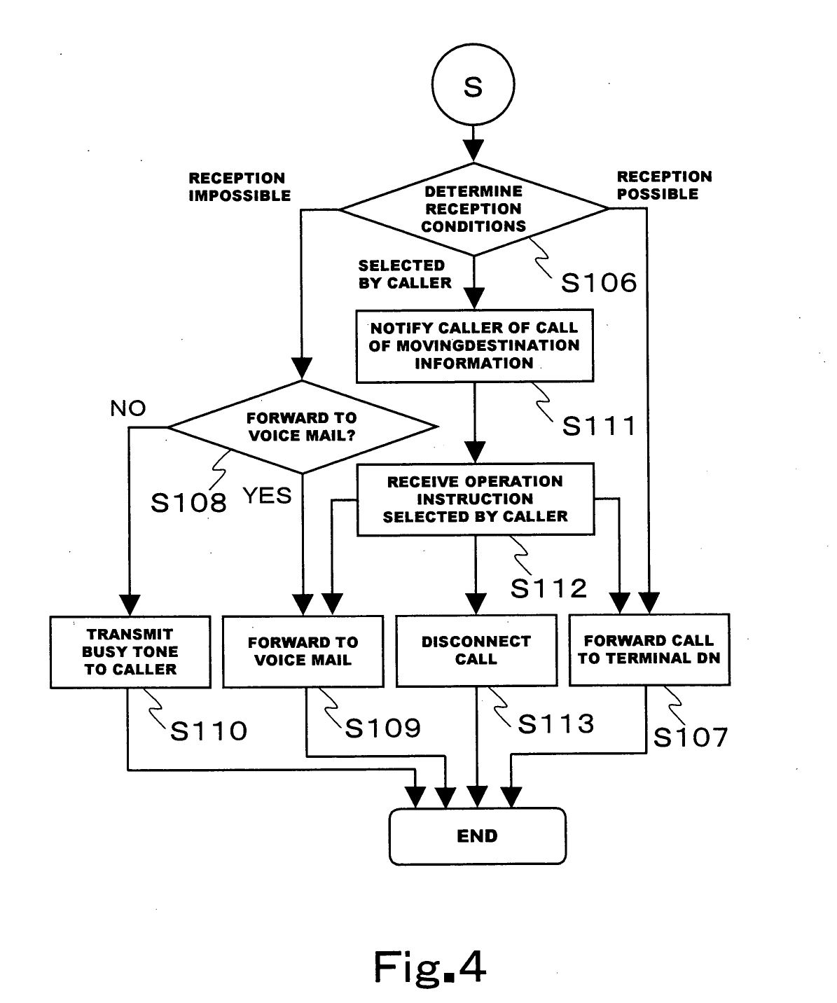

Referring to FIGS. 3 and 4, description will now be given of the operations of the telephone exchange system when a call is forwarded according to the present embodiment. It should be noted that the operations of the telephone exchange system shown in FIG. 4 are operations carried out according to conditions described in the script file.

Referring to FIG. 3, if a call is received (step S100), it is determined whether the destination of the call is a personal DN or not (step S101). If it is determined that the destination is not a personal DN, i.e., the destination is a terminal DN (“NO” in the step S101), the call is forwarded to the destination terminal DN (step S102).

If it is determined that the destination of the call is a personal DN (“YES” in the step S101), a script file corresponding to the personal DN is searched (step S103), and then, a terminal DN associated with the personal DN is searched so as to recognize the place to which the user moves (step S104).

In addition, information on the caller is investigated by detecting a caller DN, a line type and the like of the caller contained in the call (step S105).

Then, as shown in FIG. 4, reception conditions such as whether the call can be received according to the place to which the user moves, or whether the destination for the call is carried out by the judgment of the caller, are determined based on the conditions described in the script file (step S106).

When it is determined that the reception is possible, the call is forwarded to the terminal DN that is associated with the personal DN that is the original destination (step S107).

When it is determined that the reception is not possible as a result of the determination of the reception conditions (step S106), it is determined whether the call is forwarded to a voice mail (step S108). If it is determined that the call is forwarded (“YES” in the step S108), the call is forwarded to the voice mail (step S109). If it is determined that the call is not forwarded (“NO” in the step S108), a busy tone is forwarded to the caller of the call (step S110).

Further, in the determination of the reception conditions (step S106), when it is determined that the destination of the call is determined by the judgment of the caller, the place to which the user moves is notified to the caller of the call by way of a voice message to the caller or a display on the display screen of the telephone terminal (step Sill).

When a notice of an operation selected by the caller is received by means of a tone signal or the like (step S112), the call is forwarded to the terminal DN that is associated with the personal DN which is the original destination (step S107), the call is forwarded to the voice mail (step S109), or the call is disconnected (step S113) according to the received selection of the caller.

It should be noted that although the reception conditions of a call are prepared using a script file in the present embodiment, the description of the reception conditions is not limited to a script, and other languages may be used.

Further, although description is made in the above embodiment by using the place to which the user moves and the caller information as the reception conditions, the reception conditions are not limited to them. Alternatively, for example, time and date may be used as the receiving conditions, and a watch for measuring time and date is provided in the telephone exchange system. In this case, the place to which the user moves is automatically changed according to the time and the date without relying on the login by the user.

Furthermore, a plurality of script files describing different conditions for forwarding a call may be registered in advance, and a script file that sets optimal conditions may be selected when a login is performed.

Additionally, in the above embodiment, a user edits a script file and registers the script file by himself/herself Alternatively, the telephone exchange system may be so configured that a script translation unit that translates entered conditions to a script file is provided, while editorial operations are carried out visually by using a GUI (graphical user interface) as an interface with the user, and the result of the editorial operations is registered to the script registration unit through the script translation unit.

As described above, since the present invention allows describing of a plurality of reception conditions used for forwarding a call to a user, the call can be forwarded according to detailed requirements of the user.

In addition, since the operations for processing the reception conditions and the call can be described as statements using a script file, the user can set the conditions easily and in detail.

Further, since a user performs login operations through a telephone terminal located at place to which the user moves, a call can be processed under the state where the location of the user is recognized. As a result, it is possible to easily use the connection conditions according to the place to which the user moves.

What is claimed is:

1. A telephone exchange method of forwarding a call addressed to a personal DN, which is a number assigned to a user, to a forwarding telephone terminal located at a place to which the user moves, comprising:
storing a terminal DN, which is a number assigned to a telephone terminal to which the user logs in, and the personal DN is such a manner that the terminal DN is associated with the personal DN;
searching a terminal DN associated with the personal DN to which the call is addressed, thereby recognizing a place to which the user moves;
detecting caller information of the call from the call;
determining a destination to which the call is forwarded according to reception conditions which are conditions for determining the destination to which the call is forwarded based on the place to which the user moves and the caller information; and
forwarding the call to the destination to which the call is forwarded.

2. The telephone exchange method according to claim 1, further comprising:
storing the reception conditions for each personal DN; and
determining the destination to which the call is forwarded based on the reception conditions corresponding to the personal DN to which the call is addressed.

3. A telephone exchange system for forwarding a call addressed to a personal DN, which is a number assigned to a user, to a forwarding telephone terminal located at a place to which the user moves, comprising:
a personal DN/terminal DN setting unit that associates a terminal DN, which is a number assigned to a telephone terminal to which the user logs in, with the personal DN;
a personal DN/terminal DN retrieval unit that searches a terminal DN associated with the personal DN to which the call is addressed, thereby recognizing a place to which the user moves;
a caller information detection unit that detects caller information of the call from the call;
a reception condition storage unit that stores reception conditions in a destination to which the call is forwarded;
a forwarding destination determination unit that determines a destination to which the call is forwarded according to the reception conditions based on the destination to which the call is forwarded and the caller information; and
a call control unit that forwards the call to the destination to which the call is forwarded.

4. The telephone exchange system according to claim 3, wherein the reception condition storage unit stores the reception conditions for each personal DN, and the forwarding destination determination unit determines the destination to which the call is forwarded based on the reception conditions corresponding to the personal DN to which the call is addressed.

5. The telephone exchange system according to claim 3, further comprising an audio/display control unit that performs audio control and display control for the destination to which the call is forwarded,
wherein if the forwarding destination determination unit determines to forward an audio or visual message to the destination to which the call is forwarded in place of forwarding the call, the call control unit forwards the audio or visual message to the destination to which the call is forwarded through the audio/display control unit.

6. The telephone exchange system according to claim 4, further comprising:
an audio/display control unit that performs audio control and display control for the destination to which the call is forwarded,
wherein if the forwarding destination determination unit determines to forward an audio or visual message to the destination to which the call is forwarded in place of forwarding the call, the call control unit forwards the audio or visual message to the destination to which the call is forwarded through the audio/display control unit.

7. The telephone exchange system according to claim 3, wherein the forwarding destination determination unit comprises:
a location information/terminal DN conversion unit that converts location information described in the reception conditions into the terminal DN;
a personal information/personal DN conversion unit that converts personal information described in the reception conditions into the personal DN;
a translation unit that translates the reception conditions into an executable form; and
an execution unit that determines the destination to which the call is forwarded by using the translated reception conditions.

8. The telephone exchange system according to claim 4, wherein the forwarding destination determination unit comprises:
a location information/terminal DN conversion unit that converts location information described in the reception conditions into the terminal DN;
a personal information/personal DN conversion unit that converts personal information described in the reception conditions into the personal DN;
a translation unit that translates the reception conditions into an executable form; and
an execution unit that determines the destination to which the call is forwarded by using the translated reception conditions.

9. The telephone exchange system according to claim 5, wherein the forwarding destination determination unit comprises:
a location information/terminal DN conversion unit that converts location information described in the reception conditions into the terminal DN;
a personal information/personal DN conversion unit that converts personal information described in the reception conditions into the personal DN;
a translation unit that translates the reception conditions into an executable form; and
an execution unit that determines the destination to which the call is forwarded by using the translated reception conditions.

10. The telephone exchange system according to claim 6, wherein the forwarding destination determination unit comprises:
a location information/terminal DN conversion unit that converts location information described in the reception conditions into the terminal DN;
a personal information/personal DN conversion unit that converts personal information described in the reception conditions into the personal DN;
a translation unit that translates the reception conditions into an executable form; and
an execution unit that determines the destination to which the call is forwarded by using the translated reception conditions.

11. The telephone exchange system according to claim 7, wherein the reception conditions are described in a script file written in script.

12. The telephone exchange system according to claim 8, wherein the reception conditions are described in a script file written in script.

13. The telephone exchange system according to claim 9, wherein the reception conditions are described in a script file written in script.

14. The telephone exchange system according to claim 10, wherein the reception conditions are described in a script file written in script.
